(19) United States
(12) Patent Application Publication
(10) Pub. No.: US 2004/0156351 A1
(43) Pub. Date: Aug. 12, 2004

(54) Apparatus and method for making QOS-supporting polling list

(75) Inventor: Jun-whan Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/721,759

(22) Filed: Nov. 26, 2003

(30) Foreign Application Priority Data
Dec. 2, 2002 (KR) 2002-76030
Dec. 28, 2002 (KR) 2002-85914

(51) Int. Cl. H04J 3/24

(52) U.S. Cl. 370/349

(57) ABSTRACT

An apparatus and method for making a polling list based on IEEE 802.11e standards are provided. The apparatus includes a coordinator polling list making apparatus, which generates a controlled contention frame, transmits the controlled contention frame to stations on a network through a channel using a broadcast method, and when a reservation request frame from each of the stations is received as a response to the controlled contention frame through the channel during a controlled contention interval designated by the controlled contention frame, allocates a poll frame transmission sequence to the stations, from which the reservation request frame is received, using a first come first serve method based on a sequence in which reservation request frames arrive and makes a polling list including the poll frame transmission sequence; and a station polling list making apparatus, which when the controlled contention frame is received through the channel from the coordinator polling list making apparatus, contends for use of the channel according to a user priority value of a data frame so as to acquire an exclusive right of using the channel, and when the exclusive right is acquired, generates a reservation request frame as a response to the controlled contention frame and transmits the reservation request frame to the coordinator polling list making apparatus through the channel.

### CROSS-REFERENCE TO RELATED APPLICATIONS

This application claims the priority of Korean Patent Application No. 2002-76030, filed on Dec. 2, 2002, and Korean Patent Application No. 2002-85914, filed on Dec. 28, 2002, in the Korean Intellectual Property Office, the disclosures of which are incorporated herein by reference.

### BACKGROUND OF THE INVENTION

1. Field of the Invention

The present invention relates to an apparatus and method for making a polling list based on IEEE 802.11e standards.

2. Description of the Related Art

According to the IEEE 802.11e standards, a basic service set (BSS) including an access point (AP) is referred to as an infrastructure mode, and a BSS without an AP is referred to as an ad-hoc mode. A set of stations in the ad-hoc mode is referred to as an independent basic service set (IBSS). Among the functions of a media access control (MAC) protocols, a distributed coordination function (DCF) and an enhanced distributed coordination function (EDCF) providing quality of service (QOS) are operated only in the ad-hoc mode and transmit a MAC protocol data unit (MPDU) through a contention. A period of time during which the MPDU is transmitted through the contention is referred to as a contention period (CP). In the meantime, the infrastructure mode includes all of the functions included in the ad-hoc mode, a point coordination function (PCF), and a hybrid coordination function (HCF) providing QOS. The infrastructure mode include both contention and polling methods. A period of time during which the MPDU is transmitted through a poll is referred to as a contention free period (CFP). Although the IEEE 802.11e standards define a mechanism based on polling in which only a station receiving a poll frame is given a chance to transmit data, it has problems in processing multimedia data due to an unpredictable arrival delay of a beacon frame and an unknown transmission period of stations. In other words, a coordinator station schedules a beacon as a next frame to be transmitted at a target beacon transmission time (TBTT), and the scheduled beacon is transmitted while a channel is not used for a predetermined period of time. That is, at the TBTT, an arrival delay of a beacon frame occurs depending on whether a channel is being used. Arrival delay of the beacon frame causes a transmission delay of an MPDU to be transmitted during the CFP. The IEEE 802.11e standards have a problem in that stations cannot start transmission when the MPDU transmission is not completed before a coming TBTT.

FIG. 1 is a diagram showing a conventional back-off mechanism. A MAC mechanism in the ad-hoc mode is as follows. A fundamental MAC structure includes a distributed coordination function based on a carrier sense multiple access (CSMA). When transmitting an MPDU, a channel is checked to find out whether it is used. If the channel is being used, that is, is busy, the MPDU is held in standby for a predetermined period of time for back off. If the channel is not being used, that is, is idle, the MPDU is transmitted. Here, a binary back-off mechanism is used. IEEE 802.11 uses a CSMA with collision avoidance (CSMACA) as a method of transmitting an MPDU through a contention in order to reduce a possibility of collision between stations. When a channel is idle during a period of time corresponding to a DCF inter-frame space (DIFS), back-off is performed for additional transmission during a certain period of time. The certain period of time is determined by the number of slot times (9 μs in IEEE 802.11a), and each station has a contention window (CW) section in order to determine the number of slot times for a certain back-off before transmission. If the channel is still being used even after the certain back-off, the number of slot times is calculated again to set a greater back-off time. At retrial, the back-off time is determined within a double CW. The CW is managed as a minimum CW (CWmin) or a maximum CW (CWmax). If a station succeeds in transmission, it receives an acknowledgement (ACK) frame after a short inter-frame space (SIFS). If not, the station tries re-transmission. The number of re-transmissions is limited to a certain value, and when the number of re-transmissions exceeds the certain value, the relevant MPDU is removed.

The EDCF is an expanded MAC protocol for providing QOS to the DCF. Such expansion is implemented using an access category (AC) classified by a user priority (UP). The UP is a traffic type suggested in IEEE 802.11d standards and has a value from 0 to 7. 8 different UPs are classified into 4 different ACs, and an MPDU is stored in a transmission queue and transmitted through contention based on priority. Here, a station uses multiple back-offs distinguished from one another by AC parameters. As shown in FIG. 1, when a medium is idle during a period of time corresponding to an arbitrary inter-frame space (AIFS) within the CP, CW[AC] between CWmin[AC] and CWmax[AC] is arbitrarily selected, and a back-off is operated. The AIFS is a minimum priority frame space and expands in an increasing order of priority. Internally, four back-offs are performed, and an MPDU winning a contention is given an opportunity to be transmitted first. A collision occurring during the contention is referred to as an internal collision, and a collision occurring during transmission outside is referred to as an external collision. The basic concept of the EDCF is setting multiple AIFSs and back-off times according to priority in order to minimize collision. Contention according to priority gives an opportunity of transmission to a station having an MPDU with a high priority prior to other stations having an MPDU with a lower priority.

FIG. 2 is a diagram showing a procedure of performing the conventional HCF. A MAC mechanism in the infrastructure mode is as follows. In the HCF, a point coordinator transmits a poll frame to a station which can receive a poll. When the station receives the poll frame, it is given an opportunity to transmit an MPDU. After completion of data transmission, the point coordinator transmits the poll frame to a next station to give the station an opportunity to transmit an MPDU. If the station does not have any MPDU to transmit, it transmits a null frame to the point coordinator. Generally, the point coordinator transmits the poll frame to all stations using a round robin method during the CFP.

The HCF is fundamentally similar to the PCF. As shown in FIG. 2, a hybrid coordinator transmits a QOS poll frame to each station, and the station receiving the QOS poll frame transmits an MPDU. The hybrid coordinator transmits the QOS poll frame during the CP as well as the CFP. In order to distinguish the CP from the CFP, the hybrid coordinator transmits a contention free (CF) end frame. The hybrid coordinator makes a polling list to transmit the QOS poll frame during a controlled contention interval (CCI). If the hybrid coordinator broadcasts a controlled contention (CC) frame to each station, a station having an MPDU to transmit sends a reservation request (RR) frame in response to the CC frame. The hybrid coordinator makes the polling list based on the RR frame. The polling list shows sequence of stations to which a poll is to be transmitted. Accordingly, it is very important for a hybrid coordinator to make an optimal polling list to secure the QOS in the MAC.

FIG. 3 is a diagram showing a mechanism of making a polling list suggested in the IEEE 802.11e standards. According to the IEEE 802.11e standards, a hybrid coordinator makes a polling list using a CC frame and RR frames during the CCI. After transmitting the CC frame, the hybrid coordinator divides the CCI into plurality of Duration of Controlled Contention OPportunity (DCCOP) to define an interval (i.e., a slot time) during which each station can transmit the RR frame to the hybrid coordinator. Each station makes random numbers and transmits the RR frame using one among 1 through a maximum of 255 intervals. The IEEE 802.11e standards do not suggest in detail a method in which the hybrid coordinator makes the polling list using the received RR frames.

Conventionally, a station transmits the RR frame during the DCCOP selected using an arbitrary number. The DCCOP is selected regardless of the priority of data to be transmitted by a station, and it happens that all stations cannot participate in the selection. In addition, the hybrid coordinator needs to perform an algorithm for determining an order in which a QOS poll is transmitted to the stations based on the RR frames. This necessity burdens the hybrid coordinator with a heavy load. Moreover, it happens that a station having data with high priority cannot select any DCCOP. For example, when random numbers made by two stations are the same, the same DCCOP is selected, and collision occurs between the stations. As a result, transmission of the RR frames is delayed, and therefore, the stations cannot be registered in the polling list. If the stations omitted from the polling list have data with high priority, QOS cannot be secured. Furthermore, even if the RR frames are normally received, the hybrid coordinator needs to make the polling list using a unique algorithm, which increases an internal processing load on the hybrid coordinator.

### SUMMARY OF THE INVENTION

The present invention provides an apparatus and method for fairly and efficiently making a quality of service-supporting polling list.

According to an aspect of the present invention, there is provided a coordinator polling list making apparatus including a controlled contention frame transmitter, which when making a polling list is requested, generates a controlled contention frame and transmits the controlled contention frame to stations on a network through a predetermined channel using a broadcast method after a period of time corresponding to a priority inter-frame space lapses since receipt of the request of making a polling list; a reservation request frame receiver, which receives a reservation request frame from each of the stations through the predetermined channel as a response to the controlled contention frame during a controlled contention interval designated by the controlled contention frame; and a polling list making unit, which when the reservation request frame receiver receives the reservation request frame, allocates a poll frame transmission sequence to the stations, from which the reservation request frame is received, using a first come first serve method based on a sequence in which reservation request frames arrive and makes a polling list comprising the poll frame transmission sequence.

According to another aspect of the present invention, there is provided a station polling list making apparatus including a controlled contention frame receiver, which receives a controlled contention frame through a predetermined channel from a coordinator station among stations on a network; and a reservation request frame transmitter, which when the controlled contention frame is received by the controlled contention frame receiver, contends for use of the predetermined channel according to a user priority value of a data frame during a controlled contention interval designated by the controlled contention frame so as to acquire an exclusive right of using the predetermined channel, generates a reservation request frame as a response to the controlled contention frame when the exclusive right is acquired, and transmits the reservation request frame to the coordinator station through the predetermined channel.

According to still another aspect of the present invention, there is provided an apparatus for making a polling list. The apparatus includes a coordinator polling list making apparatus, which when making a polling list is requested, generates a controlled contention frame and transmits the controlled contention frame to stations on a network through a predetermined channel using a broadcast method after a period of time corresponding to a priority inter-frame space lapses since receipt of the request of making a polling list, and when a reservation request frame from each of the stations is received as a response to the controlled contention frame through the predetermined channel during a controlled contention interval designated by the controlled contention frame, allocates a poll frame transmission sequence to the stations, from which the reservation request frame is received, using a first come first serve method based on a sequence in which reservation request frames arrive and makes a polling list comprising the poll frame transmission sequence; and a station polling list making apparatus, which when the controlled contention frame is received through the predetermined channel from the coordinator polling list making apparatus, contends for use of the predetermined channel according to a user priority value of a data frame during the controlled contention interval designated by the controlled contention frame so as to acquire an exclusive right of using the predetermined channel, and when the exclusive right is acquired, generates a reservation request frame as a response to the controlled contention frame and transmits the reservation request frame to the coordinator polling list making apparatus through the predetermined channel.

According to still another aspect of the present invention, there is provided a method of making a coordinator polling list. The method includes when making a polling list is requested, generating a controlled contention frame and transmitting the controlled contention frame to stations on a network through a predetermined channel using a broadcast method after a period of time corresponding to a priority inter-frame space lapses since receipt of the request of making a polling list; receiving a reservation request frame from each of the stations as a response to the controlled contention frame through the predetermined channel during a controlled contention interval designated by the controlled contention frame; when the reservation request frame is received, allocating a poll frame transmission sequence to the stations, from which the reservation request frame is received, using a first come first serve method based on a sequence in which reservation request frames arrive and making a polling list comprising the poll frame transmission sequence.

According to still another aspect of the present invention, there is provided a method of making a station polling list. The method includes receiving a controlled contention frame through a predetermined channel from a coordinator station among stations on a network; and when the controlled contention frame is received, contending for use of the predetermined channel according to a user priority value of a data frame during a controlled contention interval designated by the controlled contention frame so as to acquire an exclusive right of using the predetermined channel, generating a reservation request frame as a response to the controlled contention frame when the exclusive right is acquired, and transmitting the reservation request frame to the coordinator station through the predetermined channel.

According to still another aspect of the present invention, there is provided a method of making a polling list. The method includes when making a polling list is requested, generating a controlled contention frame and transmitting the controlled contention frame to stations on a network through a predetermined channel using a broadcast method after a period of time corresponding to a priority inter-frame space lapses since receipt of the request of making a polling list, and when a reservation request frame from each of the stations is received as a response to the controlled contention frame through the predetermined channel during a controlled contention interval designated by the controlled contention frame, allocating a poll frame transmission sequence to the stations, from which the reservation request frame is received, using a first come first serve method based on a sequence in which reservation request frames arrive and making a polling list comprising the poll frame transmission sequence; and when the controlled contention frame is received through the predetermined channel, contending for use of the predetermined channel according to a user priority value of a data frame during the controlled contention interval designated by the controlled contention frame so as to acquire an exclusive right of using the predetermined channel, and when the exclusive right is acquired, generating a reservation request frame as a response to the controlled contention frame and transmitting the reservation request frame to the coordinator polling list making apparatus through the predetermined channel.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram showing a conventional back-off mechanism;

FIG. 2 is a diagram showing a procedure of performing a conventional hybrid coordination function (HCF);

FIG. 3 is a diagram showing a mechanism of making a polling list suggested in IEEE 802.11e standards;

FIG. 4 is a diagram showing a procedure for making a polling list according to an embodiment of the present invention;

FIG. 5 is a diagram of an apparatus for making a polling list according to an embodiment of the present invention;

FIG. 6 is a diagram showing a format of a controlled contention (CC) frame used in the present invention;

FIG. 7 is a diagram showing a format of a reservation request (RR) frame used in the present invention;

FIG. 8 is a diagram showing a format of a poll frame used in the present invention;

FIG. 9 is a flowchart of a method of making a poling list in a coordinator, according to an embodiment of the present invention;

FIG. 10 is a flowchart of a method of making a poling list in a station, according to the present invention;

FIG. 11 is a diagram showing a procedure for performing an enhanced distributed coordination function (EDCF) using the present invention; and

FIG. 12 is a graph showing the results of simulations for evaluating the performance of the EDCF using the present invention.

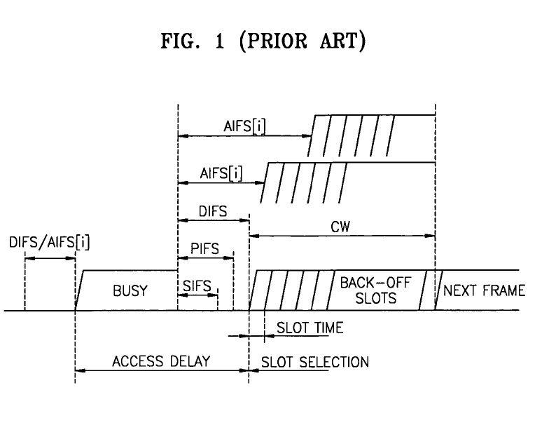

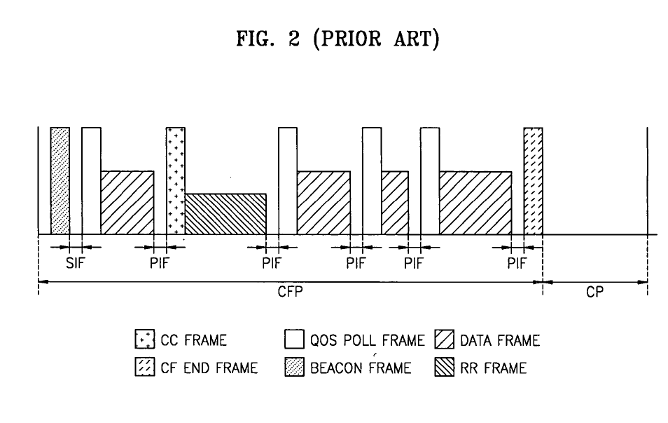

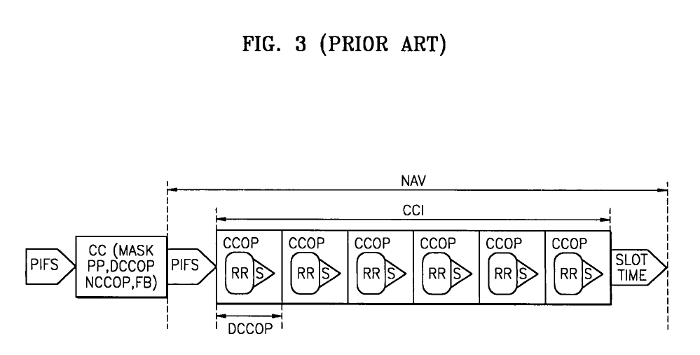

### DETAILED DESCRIPTION OF THE INVENTION

Hereinafter, preferred embodiments of the present invention will be described in detail with reference to the attached drawings.

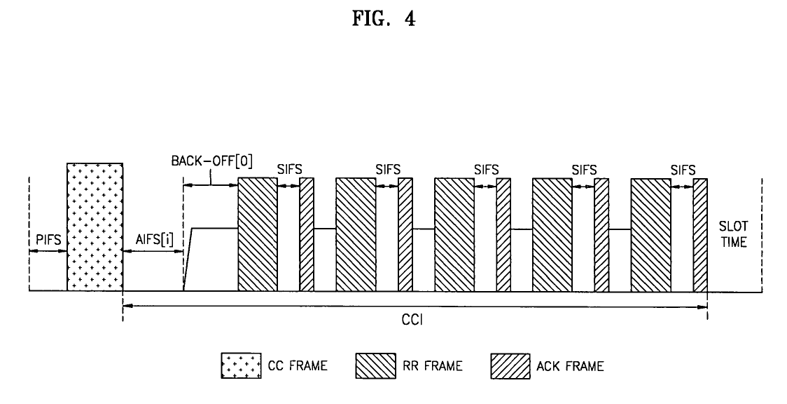

FIG. 4 is a diagram showing a procedure for making a polling list according to an embodiment of the present invention. Generally, the present invention is applied to a network environment referred to as a basic service set (BSS) defined in IEEE 802.11 wireless LAN standards. The BSS is a set of stations within a distance allowing communication. Since a range of propagation is uncertain, the BSS does not indicate a particular region. The present invention is applied to an infrastructure mode having an access point (AP) performing relay between stations constituting the BSS. The AP is a coordinator station. The infrastructure mode includes a point coordination function (PCF) or a hybrid coordination function (HCF) supporting quality of service (QOS). The present invention is applied to the HCF supporting the QOS, and thus, the coordinator is a hybrid coordinator. The polling list indicates an order in which priority of data transmission is given, and a station with a high order in the polling list is expected to have transmission data with high priority. Making the polling list needs to be fairly and efficiently performed between the coordinator and the stations to transmit data without burdening the stations and the coordinator with a heavy load.

As shown in FIG. 4, when receiving a request to make the polling list, the coordinator broadcasts a controlled contention (CC) frame to all stations included in the BSS including the coordinator after a period of time corresponding to a priority inter-frame space (PIFS) lapses since receipt of the request. The PIFS is composed of a short inter-frame space (SIFS) and a single slot time. The lengths of the SIFS and the slot time are determined at a physical layer below a media access control (MAC) layer. According to the IEEE 802.11 standards, the CC frame can be transmitted while a channel is not being used during a period of time corresponding to the PIFS. Stations having a MAC protocol data unit (MPDU) to transmit prepares for transmitting a reservation request (RR) frame in response to the CC frame. The stations transmit the RR frame in response to the CC frame using an enhanced distributed coordination function (EDCF), and the coordinator transmits an acknowledgement (ACK) frame of the RR frame. The stations transmit the RR frame during a controlled contention interval (CCI), and the CC frame is used to inform each station of the CCI and an instant of time the RR frame is transmitted. The coordinator transmits the CC frame when the polling list is empty or when the polling list is not completed within the CCI. The CCI is determined according to the number of stations. With respect to RR frames transmitted from the stations based on the EDCF, the coordinator makes the polling list using a first come first serve (FCFS) method. The coordinator transmits a poll frame to a station according to an order registered in the polling list.

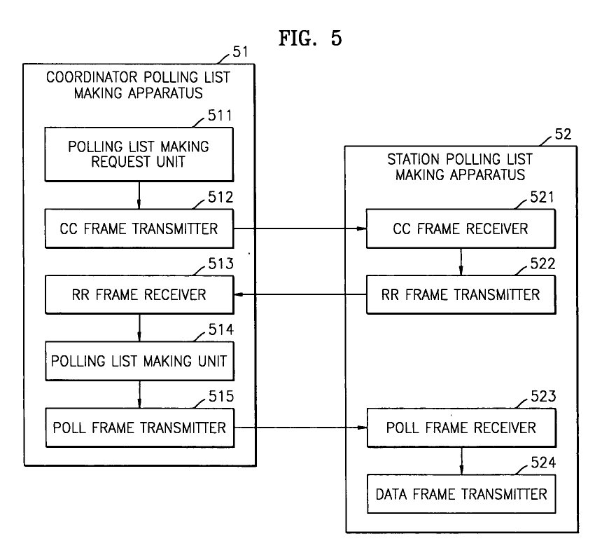

FIG. 5 is a diagram of an apparatus for making a polling list according to an embodiment of the present invention. A coordinator polling list making apparatus 51 corresponds to a coordinator station in the apparatus and includes a polling list making request unit 511, a CC frame transmitter 512, an RR frame receiver 513, a polling list making unit 514, and a poll frame transmitter 515.

The polling list making request unit 511 requests to make a polling list when a polling list is not made or when RR frames are not received from all of stations that have transmitted the RR frames during a CCI. In other words, when a polling list in the coordinator station is empty, or when a polling list is not completed because all of the RR frames transmitted from stations are not received during the CCI, the polling list making request unit 511 requests to make the polling list. The CCI is a period during which the polling list is made through a contention for channel use between the stations according to a user priority (UP) value of data to be transmitted by each station. The length of the CCI is proportional to the number of station on a network. As the number of stations increases, time taken for making the polling list increases, and therefore, the length of the CCI increases.

The CC frame transmitter 512 generates a CC frame in response to the request to make the polling list, and transmits the CC frame to stations on a predetermined network through a predetermined channel using a broadcast method after a period of time corresponding to a PIFS lapses since receipt of the request. According to the IEEE 802.11 standards, the CC frame can be transmitted while the channel is not being used during the period of time corresponding to the PIFS. For this reason, after the period of time corresponding to the PIFS lapses, the CC frame is transmitted to all stations in a BSS through the channel using the broadcast method. Here, the CC frame is a kind of management frame and includes a frame control field, a period/ID field, a receiver address field, a BSS ID field, a CCI length field, and a frame inspection sequence field.

The RR frame receiver 513 receives an RR frame as a response to the CC frame transmitted by the CC frame transmitter 512 through the channel during the CCI designated by the CC frame. In other words, the coordinator polling list making apparatus 51 receives RR frames from a plurality of stations receiving the CC frame. The RR frame is a management frame and includes a frame control field, a period/ID field, a receiver address field, a BSS ID field, a QOS control field, an association ID field, and a frame inspection sequence field. In order to support QOS, values of a data rate, a burst size, a delay bound, and a jitter bound are recorded in the QOS control field. Each station receiving the CC frame records QOS control information on an MPDU to transmit in an RR frame and then transmits the RR frame to the coordinator polling list making apparatus 51.

When the RR frame receiver 513 receives RR frames, the polling list making unit 514 allocates a poll frame transmission sequence to the stations having transmitted the received RR frame using an FCFS method based on an order in which the received RR frames arrive and makes a polling list including the poll frame transmission sequence. In other words, the coordinator polling list making apparatus 51 makes the polling list by storing the RR frames in a queue in received order. The received order of the RR frames depends on a contention between stations according to priority, and therefore, a station having data with a highest priority value can receive a poll frame first. The poll frame is a management frame and includes a frame control field, a period/ID field, a receiver address field, a BSS ID field, a QOS control field, a data transmitting/receiving period length field, and a frame inspection sequence field. A poll frame supporting the QOS is referred to as a QOS poll frame.

The poll frame transmitter 515 transmits a poll frame to the stations from which the RR frames are received by the RR frame receiver 513 through the channel according to the poll frame transmission sequence included in the polling list made by the polling list making unit 514. In other words, according to the polling list, a QOS poll frame is sequentially transmitted to the stations. Values of factors, such as a data rate, a burst size, a delay bound, and a jitter bound, for QOS are recorded in the QOS control field of the QOS poll frame. A station receiving the QOS poll frame transmits an MPDU based on the factors for QOS recorded in the QOS poll frame.

A station polling list making apparatus 52 corresponds to a station in the apparatus for making a polling list according to the embodiment of the present invention and includes a CC frame receiver 521, an RR frame transmitter 522, a poll frame receiver 523, and a data frame transmitter 524.

The CC frame receiver 521 receives the CC frame through the predetermined channel from the coordinator station among the stations on the predetermined network. As described above, the CC frame includes a frame control field, a period/ID field, a receiver address field, a BSS ID field, a CCI length field, and a frame inspection sequence field.

When the CC frame receivers 521 receives the CC frame, the RR frame transmitter 522 contends for the use of the predetermined channel according to the UP value of a data frame to be transmitted during the CCI designated by the received CC frame. When the CC frame receivers 521 exclusively acquires the use of the predetermined channel as the result of the contention, it generates and transmits an RR frame as a response to the CC frame to the coordinator station through the predetermined channel. As described above, the CCI increases in proportional to the number of station included in the BSS. If a station does not transmit an RR frame within current CCI, it waits for a next CC frame. The station that does not transmit the RR frame within the current CCI is determined as having a lower priority than stations transmitting the RR frame and participates in a contention again after receiving the next CC frame.

The following description concerns the contention for the use of a channel. The RR frame transmitter 522 sets a coordination inter-frame space value and a convention window (CW) value according to the UP value and detects whether the channel is being used after a period of time corresponding to the coordination inter-frame space value and a back-off time corresponding to the CW value sequentially lapse. If the channel is not being used, the RR frame transmitter 522 acquires the exclusive right of using the channel. However, if the channel is being used, the RR frame transmitter 522 does not acquire the right of using the channel and resets the CW value to extend using a back-off algorithm. According to the IEEE 802.11 standards, 8 UP values allocated to MPDUs to be transmitted are classified into 4 access categories (ACs), and channel contention is performed based on a coordination inter-frame space value and a CW value included in an AC into which an MPDU is classified. As described above, the RR frame includes a frame control field, a period/ID field, a receiver address field, a BSS ID field, a QOS control field, an association ID field, and a frame inspection sequence field. The QOS control field contains values of a data rate, a burst size, a delay bound, and a jitter bound.

The poll frame receiver 523 receives a poll frame, which is transmitted through a channel from the coordinator station according to the poll frame transmission sequence included in the polling list. Since poll frame transmission sequence is determined according to the UP values, a station having data with a highest UP value receives the poll frame first. As described above, the poll frame includes a frame control field, a period/ID field, a receiver address field, a BSS ID field, a QOS control field, a data transmitting/receiving period length field, and a frame inspection sequence field.

When the poll frame receiver 523 receives the poll frame, the data frame transmitter 524 transmits a data frame to a destination station of the data frame through a channel during a data transmitting/receiving period designated by the received poll frame. In other words, according to the priority of data to be transmitted, the station receiving the poll frame transmits the data frame to a destination station of the data frame during a data transmitting/receiving period indicated by the data transmitting/receiving period length field in the poll frame.

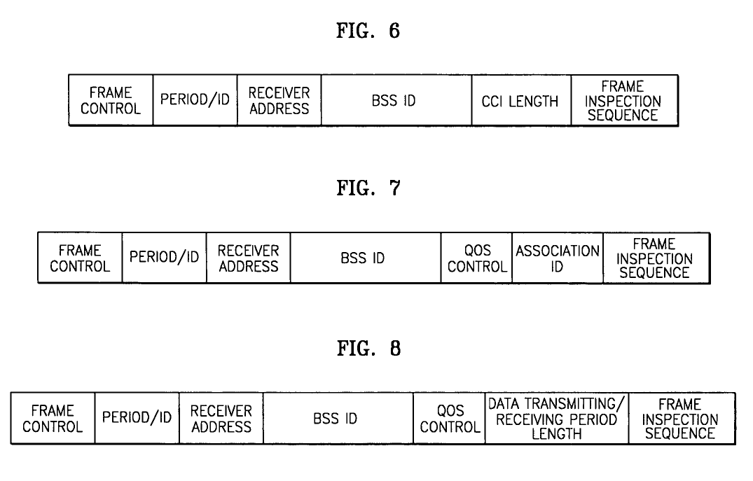

FIG. 6 is a diagram showing a format of a CC frame used in the present invention. The CC frame includes a frame control field, a period/ID field, a receiver address field, a BSS ID field, a CCI length field, and a frame inspection sequence field. The frame control field indicates whether the relevant frame is a data frame, a control frame, or a management frame. The period/ID field indicates a network allocation vector (NAV) or an ID of a relevant station within a relevant BSS. The receiver address field indicates an address of a receiver to receive a response frame. The BSS ID field indicates an ID of the relevant BSS. The CCI length field indicates a length of a period during which a polling list is made. The frame inspection sequence field indicates frame inspection sequence according to IEEE 802 LAN standards.

FIG. 7 is a diagram showing a format of an RR frame used in the present invention. The RR frame includes a frame control field, a period/ID field, a receiver address field, a BSS ID field, a QOS control field, an association ID field, and a frame inspection sequence field. The frame control field, the period/ID field, the receiver address field, the BSS ID field, and the frame inspection sequence field are the same as those in the CC frame shown in FIG. 6. The QOS control field indicates a data rate, a burst size, a delay bound, and a jitter bound. The association ID field indicates an ID arbitrarily allocated by an AP within the BSS.

FIG. 8 is a diagram showing a format of a poll frame used in the present invention. The poll frame includes a frame control field, a period/ID field, a receiver address field, a BSS ID field, a QOS control field, a data transmitting/receiving period length field, and a frame inspection sequence field. The frame control field, the period/ID field, the receiver address field, the BSS ID field, the QOS control field, and the frame inspection sequence field are the same as those in the CC frame shown in FIG. 6 and the RR frame shown in FIG. 7. The data transmitting/receiving period length field indicates a period during which the station receiving the poll frame can use a predetermined channel.

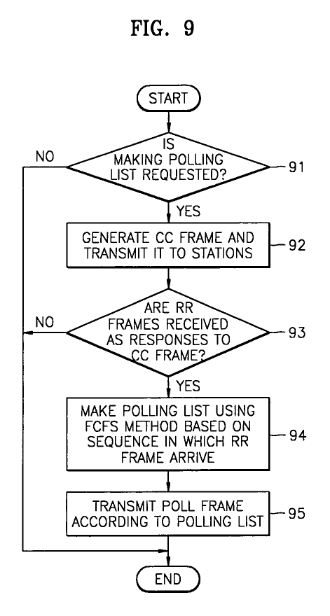

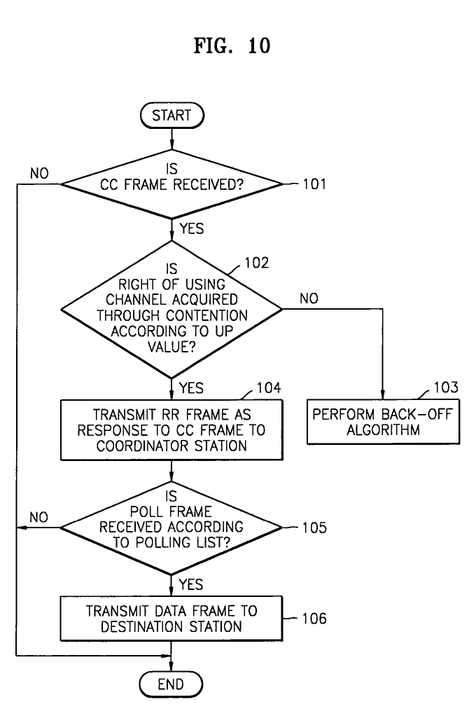

FIG. 9 is a flowchart of a method of making a poling list in a coordinator, according to an embodiment of the present invention. When a polling list is not made or when all RR frames are not received from stations that have transmitted the RR frames during a CCI, making a polling list is requested (91). When making a polling list is requested, a CC frame is generated and transmitted to stations on a predetermined network through a predetermined channel using a broadcast method after a period of time corresponding to a PIFS lapses since receipt of the request of making a polling list (92). Thereafter, RR frames are received as responses to the CC frame through the predetermined channel during the CCI designated by the CC frame (93). When the RR frames are received, a poll frame transmission sequence is allocated to the stations having transmitted the RR frame, using an FCFS method based on sequence in which the RR frames arrive, and a polling list including the poll frame transmission sequence is made (94). Thereafter, a poll frame is transmitted to each station through the predetermined channel according to the poll frame transmission sequence included in the polling list (95).

FIG. 10 is a flowchart of a method of making a poling list in a station, according to the present invention. The station receives a CC frame through a predetermined channel from a coordinator station among stations on a predetermined network (101). Next, after receiving the CC frame, when the station acquires a right of exclusively using the predetermined channel through a contention according to a UP value of a data frame to transmit during a CCI designated by the received CC frame (102), the station generates an RR frame as a response to the CC frame and transmits it to the coordinator station through the predetermined channel (104). The contention for the use of the predetermined channel is performed as follows. The station sets a coordination inter-frame space value and a CW value according to the UP value and detects whether the predetermined channel is being used after a period of time corresponding to the coordination inter-frame space value and a back-off time corresponding to the CW value sequentially lapse. If the predetermined channel is not being used, the station acquires an exclusive right of using the predetermined channel. If not, the station does not acquires the exclusive right of using the predetermined channel (102) and resets the CW value to extend using a back-off algorithm (103).

A poll frame transmitted according to a poll frame transmission sequence included in the polling list is received from the coordinator station through the predetermined channel (105). Next, when the poll frame is received (105), the station transmits the data frame to a destination station among the station on the predetermined network through the predetermined channel during a data transmitting/receiving period designated by the poll frame (106).

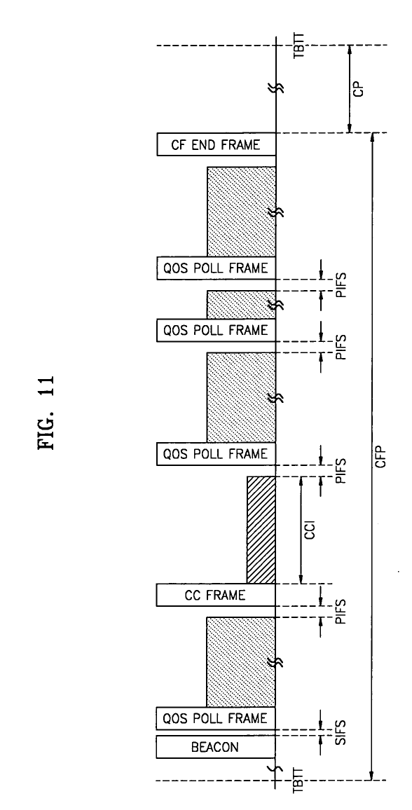

FIG. 11 is a diagram showing a procedure for performing the EDCF using the present invention. According to the present invention, the EDCF supporting the QOS can be fairly and efficiently performed, as shown in FIG. 11. When a coordinator station transmits a bean frame at an interval of a target beacon transmission time (TBTT), all stations in a BSS receive the beacon frame and adjust a local timer according to the beacon frame so that they are synchronized with one another. After a period of time corresponding to a SIFS lapses since the transmission of the beacon frame, the coordinator station transmits a QOS poll frame so that data transmission/reception sequence among the stations is determined. When a polling list is empty or not completed, in order to make a polling list the coordinator station transmits a CC frame to all of the stations in the BSS managed by the coordinator station. The coordinator station makes a polling list during a CCI. After a period of time corresponding to a PIFS lapses since the completion of the polling list, the coordinator station transmits a QOS poll frame to a station having data with a highest priority. The station receiving the QOS poll frame transmits a data frame during a data transmitting/receiving period and receives an ACK frame of the data frame. After the period of time corresponding to the PIFS lapses since the termination of the data transmitting/receiving period, the coordinator station transmits a QOS poll frame to a station having data with a second highest priority. Such a procedure is continued before the coordinator station transmits a contention free (CF) end frame. Thereafter, a contention period during which data is transmitted and received only through a contention for the use of a channel is continued.

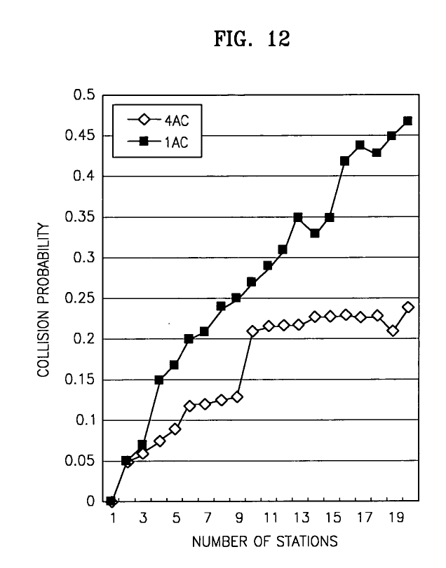

FIG. 12 is a graph showing the results of simulations for evaluating the performance of the EDCF using the present invention. As shown in FIG. 12, A CC/RR mechanism using the EDCF was evaluated through simulations. In order to make evaluation criteria, collision tests were performed according to the number of stations. According to IEEE 802.11a standards, logically a maximum of 256 stations can be served in a single BSS. However, physically a maximum of 20 stations can be served. The 20 stations can secure only a minimum bandwidth for data transmission. Accordingly, 15 or less stations can be actually served in a single BSS.

In the simulations, a collision probability was induced from an average CW value. The graph of FIG. 12 shows the results of simulating a worst contention and a usual contention when 0 through 20 stations participated in a contention. At a low collision probability, data transmission can be guaranteed according to priority. However, if a collision occurs, a back-off is performed, and therefore, a probability that a station having a lower priority transmits an RR frame prior to a station having a higher priority increases. In FIG. 12, a case where four ACs existed is compared with a case where one AC existed. The case where one AC existed showed the worst contention. In the case where four ACs existed, when the number of stations was 9, the collision probability rapidly increased. When the number of ACs increases, the collision probability decreases, but a complexity increases. Accordingly, an optimum number of stations in a single BSS is 8 through 9. For example, when 9 stations contended, the collision probability was 0.16 in the usual contention and 0.25 in the worst contention.

The above-described preferred embodiments of the present invention can be realized as programs, which can be executed in a universal digital computer through a computer readable recording medium. Data structures used in the above-described preferred embodiments can be recorded in the computer readable recording medium using various means. The computer readable recording medium may be a storage media, such as a magnetic storage medium (for example, a ROM, a floppy disc, or a hard disc), an optical readable medium (for example, a CD-ROM or DVD), or carrier waves (for example, transmitted through Internet).

According to the present invention, a QOS-supporting polling list is made, and a poll is given first to a station having data with a highest priority, so that important data can be reliably transmitted first. In addition, since a FCFS method is used, a coordinator does not need a unique algorithm used to make a polling list, and therefore, a processing burden on the coordinator is reduced. Furthermore, when the number of stations is small, the length of a CCI decreases, and therefore, a period for data transmission increases. As described above, the present invention solves the problems of the IEEE 802.11e standards and complements the IEEE 802.11e standards.

Although a few embodiments of the present invention have been shown and described, it will be appreciated by those skilled in the art that changes may be made in these elements without departing from the principles and spirit of the invention, the scope of which is defined in the appended claims and their equivalents.

What is claimed is:

1. A coordinator polling list making apparatus comprises:
a controlled contention frame transmitter, which when making a polling list is requested, generates a controlled contention frame and transmits the controlled contention frame to stations on a network through a predetermined channel using a broadcast method after a period of time corresponding to a priority inter-frame space lapses since receipt of the request of making a polling list;
a reservation request frame receiver, which receives a reservation request frame from each of the stations through the predetermined channel as a response to the controlled contention frame during a controlled contention interval designated by the controlled contention frame; and
a polling list making unit, which when the reservation request frame receiver receives the reservation request frame, allocates a poll frame transmission sequence to the stations, from which the reservation request frame is received, using a first come first serve method based on a sequence in which reservation request frames arrive and makes a polling list comprising the poll frame transmission sequence.

2. The coordinator polling list making apparatus of claim 1, further comprising:
a polling frame making request unit, which requests to make the polling list when the polling list is not made or when all reservation request frames are not received from the stations having transmitted the reservation request frames during the controlled contention interval; and
a poll frame transmitter, which transmits a poll frame to each of the stations, having transmitted the reservation request frames that are received by the reservation request frame receiver, through the predetermined channel according to the poll frame transmission sequence comprised in the polling list made by the polling list making unit.

3. The coordinator polling list making apparatus of claim 2, wherein a length of the controlled contention interval is proportional to the number of stations on the network.

4. The coordinator polling list making apparatus of claim 2, wherein the network is a basic service set defined in IEEE 802.11 wireless LAN standards.

5. The coordinator polling list making apparatus of claim 4, wherein the controlled contention frame comprises a frame control field, a period/ID field, a receiver address field, a basic service set ID field, a controlled contention interval length field, and a frame inspection sequence field;
the reservation request frame comprises a frame control field, a period/ID field, a receiver address field, a basic service set ID field, a quality of service control field, an association ID field, and a frame inspection sequence field;
the poll frame comprises a frame control field, a period/ID field, a receiver address field, a basic service set ID field, a quality of service control field, a data transmitting/receiving period length field, and a frame inspection sequence field; and
the quality of service control field indicates a data rate, a burst size, a delay bound, and a jitter bound.

6. A station polling list making apparatus comprising:
a controlled contention frame receiver, which receives a controlled contention frame through a predetermined channel from a coordinator station among stations on a network; and
a reservation request frame transmitter, which when the controlled contention frame is received by the controlled contention frame receiver, contends for use of the predetermined channel according to a user priority value of a data frame during a controlled contention interval designated by the controlled contention frame so as to acquire an exclusive right of using the predetermined channel, generates a reservation request frame as a response to the controlled contention frame when the exclusive right is acquired, and transmits the reservation request frame to the coordinator station through the predetermined channel.

7. The station polling list making apparatus of claim 6, the reservation request frame transmitter sets a coordination inter-frame space value and a contention window value according to the user priority value, detects whether the predetermined channel is being used after a period of time corresponding to the coordination inter-frame space value and a back-off time corresponding to the contention window value lapse, acquires the exclusive right of using the predetermined channel if the predetermined channel is not being used, and does not acquires the exclusive right of using the predetermined channel and resets the contention window value to be extended using a back-off algorithm if the predetermined channel is being used.

8. The station polling list making apparatus of claim 6, further comprising:
a poll frame receiver, which receives a poll frame transmitted through the predetermined channel from the coordinator station according to polling frame transmission sequence comprised in a polling list; and
a data frame transmitter, which when the poll frame is received by the poll frame receiver, transmits the data frame to a destination station among the stations through the predetermined channel during a data transmitting/receiving period designated by the poll frame.

9. The station polling list making apparatus of claim 8, wherein a length of the controlled contention interval is proportional to the number of stations.

10. The station polling list making apparatus of claim 8, wherein the network is a basic service set defined in IEEE 802.11 wireless LAN standards.

11. The station polling list making apparatus of claim 10, wherein the controlled contention frame comprises a frame control field, a period/ID field, a receiver address field, a basic service set ID field, a controlled contention interval length field, and a frame inspection sequence field;
the reservation request frame comprises a frame control field, a period/ID field, a receiver address field, a basic service set ID field, a quality of service control field, an association ID field, and a frame inspection sequence field;
the poll frame comprises a frame control field, a period/ID field, a receiver address field, a basic service set ID field, a quality of service control field, a data transmitting/receiving period length field, and a frame inspection sequence field; and
the quality of service control field indicates a data rate, a burst size, a delay bound, and a jitter bound.

12. An apparatus for making a polling list, comprising:
a coordinator polling list making apparatus, which when making a polling list is requested, generates a controlled contention frame and transmits the controlled contention frame to stations on a network through a predetermined channel using a broadcast method after a period of time corresponding to a priority inter-frame space lapses since receipt of the request of making a polling list, and when a reservation request frame from each of the stations is received as a response to the controlled contention frame through the predetermined channel during a controlled contention interval designated by the controlled contention frame, allocates a poll frame transmission sequence to the stations, from which the reservation request frame is received, using a first come first serve method based on a sequence in which reservation request frames arrive and makes a polling list comprising the poll frame transmission sequence; and
a station polling list making apparatus, which when the controlled contention frame is received through the predetermined channel from the coordinator polling list making apparatus, contends for use of the predetermined channel according to a user priority value of a data frame during the controlled contention interval designated by the controlled contention frame so as to acquire an exclusive right of using the predetermined channel, and when the exclusive right is acquired, generates a reservation request frame as a response to the controlled contention frame and transmits the reservation request frame to the coordinator polling list making apparatus through the predetermined channel.

13. The apparatus of claim 12, wherein the coordinator polling list making apparatus requests to make the polling list when the polling list is not made or when all reservation request frames are not received from the stations having transmitted the reservation request frames during the controlled contention interval, and transmits a poll frame to each of the stations, having transmitted the reservation request frames that are received, through the predetermined channel according to the poll frame transmission sequence comprised in the polling list; and
when the station polling list making apparatus receives the poll frame transmitted through the predetermined channel from the coordinator polling list making apparatus according to the polling frame transmission sequence comprised in the polling list, the station polling list making apparatus transmits the data frame to a destination station among the stations through the predetermined channel during a data transmitting/receiving period designated by the poll frame.

14. The apparatus of claim 13, wherein a length of the controlled contention interval is proportional to the number of stations.

15. The apparatus of claim 13, wherein the network is a basic service set defined in IEEE 802.11 wireless LAN standards.

16. The apparatus of claim 15, wherein the controlled contention frame comprises a frame control field, a period/ID field, a receiver address field, a basic service set ID field, a controlled contention interval length field, and a frame inspection sequence field;
the reservation request frame comprises a frame control field, a period/ID field, a receiver address field, a basic service set ID field, a quality of service control field, an association ID field, and a frame inspection sequence field;
the poll frame comprises a frame control field, a period/ID field, a receiver address field, a basic service set ID field, a quality of service control field, a data transmitting/receiving period length field, and a frame inspection sequence field; and
the quality of service control field indicates a data rate, a burst size, a delay bound, and a jitter bound.

17. A method of making a coordinator polling list, comprising:
when making a polling list is requested, generating a controlled contention frame and transmitting the controlled contention frame to stations on a network through a predetermined channel using a broadcast method after a period of time corresponding to a priority inter-frame space lapses since receipt of the request of making a polling list;
receiving a reservation request frame from each of the stations as a response to the controlled contention frame through the predetermined channel during a controlled contention interval designated by the controlled contention frame;
when the reservation request frame is received, allocating a poll frame transmission sequence to the stations, from which the reservation request frame is received, using a first come first serve method based on a sequence in which reservation request frames arrive and making a polling list comprising the poll frame transmission sequence.

18. The method of claim 17, further comprising:
requesting to make the polling list when the polling list is not made or when all reservation request frames are not received from the stations having transmitted the reservation request frames, before generating the controlled contention frame during the controlled contention interval; and
transmitting a poll frame to each of the stations, having transmitted the reservation request frames that are received, through the predetermined channel according to the poll frame transmission sequence comprised in the polling list, after making the polling list.

19. The method of claim 18, wherein a length of the controlled contention interval is proportional to the number of stations.

20. The method of claim 18, wherein the network is a basic service set defined in IEEE 802.11 wireless LAN standards.

21. The method of claim 20, wherein the controlled contention frame comprises a frame control field, a period/ID field, a receiver address field, a basic service set ID field, a controlled contention interval length field, and a frame inspection sequence field;
the reservation request frame comprises a frame control field, a period/ID field, a receiver address field, a basic service set ID field, a quality of service control field, an association ID field, and a frame inspection sequence field;
the poll frame comprises a frame control field, a period/ID field, a receiver address field, a basic service set ID field, a quality of service control field, a data transmitting/receiving period length field, and a frame inspection sequence field; and
the quality of service control field indicates a data rate, a burst size, a delay bound, and a jitter bound.

22. A method of making a station polling list, comprising:
(a) receiving a controlled contention frame through a predetermined channel from a coordinator station among stations on a network; and
(b) when the controlled contention frame is received, contending for use of the predetermined channel according to a user priority value of a data frame during a controlled contention interval designated by the controlled contention frame so as to acquire an exclusive right of using the predetermined channel, generating a reservation request frame as a response to the controlled contention frame when the exclusive right is acquired, and transmitting the reservation request frame to the coordinator station through the predetermined channel.

23. The method of claim 22, wherein step (b) comprises setting a coordination inter-frame space value and a contention window value according to the user priority value, detecting whether the predetermined channel is being used after a period of time corresponding to the coordination inter-frame space value and a back-off time corresponding to the contention window value sequentially lapse, acquiring the exclusive right of using the predetermined channel if the predetermined channel is not being used, and resetting the contention window value to be extended using a back-off algorithm when the exclusive right of using the predetermined channel is not acquired because the predetermined channel is being used.

24. The method of claim 22, further comprising:
(c) receiving a poll frame transmitted through the predetermined channel from the coordinator station according to polling frame transmission sequence comprised in a polling list; and
(d) when the poll frame is received, transmitting the data frame to a destination station among the stations through the predetermined channel during a data transmitting/receiving period designated by the poll frame.

25. The method of claim 24, wherein a length of the controlled contention interval is proportional to the number of stations.

26. The method of claim 24, wherein the network is a basic service set defined in IEEE 802.11 wireless LAN standards.

27. The method of claim 26, wherein the controlled contention frame comprises a frame control field, a period/ID field, a receiver address field, a basic service set ID field, a controlled contention interval length field, and a frame inspection sequence field;
the reservation request frame comprises a frame control field, a period/ID field, a receiver address field, a basic service set ID field, a quality of service control field, an association ID field, and a frame inspection sequence field;
the poll frame comprises a frame control field, a period/ID field, a receiver address field, a basic service set ID field, a quality of service control field, a data transmitting/receiving period length field, and a frame inspection sequence field; and
the quality of service control field indicates a data rate, a burst size, a delay bound, and a jitter bound.

28. A method of making a polling list, comprising:
(a) when making a polling list is requested, generating a controlled contention frame and transmitting the controlled contention frame to stations on a network through a predetermined channel using a broadcast method after a period of time corresponding to a priority inter-frame space lapses since receipt of the request of making a polling list, and when a reservation request frame from each of the stations is received as a response to the controlled contention frame through the predetermined channel during a controlled contention interval designated by the controlled contention frame, allocating a poll frame transmission sequence to the stations, from which the reservation request frame is received, using a first come first serve method based on a sequence in which reservation request frames arrive and making a polling list comprising the poll frame transmission sequence; and
(b) when the controlled contention frame is received through the predetermined channel, contending for use of the predetermined channel according to a user priority value of a data frame during the controlled contention interval designated by the controlled contention frame so as to acquire an exclusive right of using the predetermined channel, and when the exclusive right is acquired, generating a reservation request frame as a response to the controlled contention frame and transmitting the reservation request frame to the coordinator polling list making apparatus through the predetermined channel.

29. The method of claim 28, wherein step (a) comprises requesting to make the polling list when the polling list is not made or when all reservation request frames are not received from the stations having transmitted the reservation request frames during the controlled contention interval, and transmitting a poll frame to each of the stations, having transmitted the reservation request frames that are received, through the predetermined channel according to the poll frame transmission sequence comprised in the polling list; and
step (b) comprises when the poll frame transmitted through the predetermined channel according to the polling frame transmission sequence comprised in the polling list is received, transmitting the data frame to a destination station among the stations through the predetermined channel during a data transmitting/receiving period designated by the poll frame.

30. The method of claim 29, wherein a length of the controlled contention interval is proportional to the number of stations.

31. The method of claim 29, wherein the network is a basic service set defined in IEEE 802.11 wireless LAN standards.

32. The method of claim 31, wherein the controlled contention frame comprises a frame control field, a period/ID field, a receiver address field, a basic service set ID field, a controlled contention interval length field, and a frame inspection sequence field;
the reservation request frame comprises a frame control field, a period/ID field, a receiver address field, a basic service set ID field, a quality of service control field, an association ID field, and a frame inspection sequence field;
the poll frame comprises a frame control field, a period/ID field, a receiver address field, a basic service set ID field, a quality of service control field, a data transmitting/receiving period length field, and a frame inspection sequence field; and
the quality of service control field indicates a data rate, a burst size, a delay bound, and a jitter bound.

33. A computer readable recording medium having embodied therein a computer program for the method of claim 17.

34. A computer readable recording medium having embodied therein a computer program for the method of claim 22.

35. A computer readable recording medium having embodied therein a computer program for the method of claim 28.
